(19) United States
(12) Patent Application Publication
(10) Pub. No.: US 2026/0012090 A1
(43) Pub. Date: Jan. 8, 2026

(54) Circuit Device And Switching Regulator

(71) Applicant: SEIKO EPSON CORPORATION, Tokyo (JP)

(72) Inventors: Kei ISHIMARU, Chino (JP); Yoshiyuki YAMAGUCHI, Matsumoto (JP); Kinya MATSUDA, Matsumoto (JP)

(21) Appl. No.: 19/256,543

(22) Filed: Jul. 1, 2025

(30) Foreign Application Priority Data
Jul. 2, 2024 (JP) 2024-106577

(51) Int. Cl. H02M 3/156

(52) U.S. Cl. CPC H02M 3/156

(57) ABSTRACT

The circuit device includes a control circuit to which a first feedback voltage corresponding to an output voltage is input, the control circuit performing pulse modulation control of controlling the output voltage to a given constant voltage based on the first feedback voltage and performing switching control on a switching element based on a result of the pulse modulation control and a first comparator to which a second feedback voltage corresponding to the output voltage is input, the first comparator comparing the second feedback voltage and a reference voltage and outputting a detection signal that becomes active when the second feedback voltage becomes equal to or lower than the reference voltage. The control circuit turns on the switching element when the detection signal becomes active.

The present application is based on, and claims priority from JP Application Serial Number 2024-106577, filed Jul. 2, 2024, the disclosure of which is hereby incorporated by reference herein in its entirety.

### BACKGROUND

### 1. Technical Field

The present disclosure relates to a circuit device, a switching regulator, and the like.

### 2. Related Art

U.S. Patent Application Publication No. 2021/0083583 discloses a DCDC converter including an error amplifier that compares an output voltage and a reference voltage, a peak current comparator that compares a coil current and an output of the error amplifier to generate a peak detection voltage, an off-time timer circuit that generates an off-time signal for setting an off-time, a control logic that generates a signal for driving a power stage based on the peak detection voltage and the off-time signal, and a power stage.

U.S. Patent Application Publication No. 2021/0083583 is an example of the related art.

When a load current of a switching regulator steeply increases, there is a problem in that an output voltage transiently drops. For example, in U.S. Patent Application Publication No. 2021/0083583, feedback is delayed because of a delay of an error amplifier or the like, whereby a transient drop in an output voltage is likely to increase.

### SUMMARY

An aspect of the present disclosure relates to a circuit device used in a switching regulator that outputs an output voltage obtained by regulating a power supply voltage with an inductor and a switching element that drives the inductor, the circuit device including: a control circuit to which a first feedback voltage corresponding to the output voltage is input, the control circuit performing pulse modulation control of controlling the output voltage to a given constant voltage based on the first feedback voltage and performing switching control on the switching element based on a result of the pulse modulation control; and a first comparator to which a second feedback voltage corresponding to the output voltage is input, the first comparator comparing the second feedback voltage and a reference voltage and outputting a detection signal that becomes active when the second feedback voltage becomes equal to or lower than the reference voltage, wherein the control circuit turns on the switching element when the detection signal becomes active.

Another aspect of the present disclosure relates to a switching regulator including: the circuit device explained above; the switching element; and the inductor.

### BRIEF DESCRIPTION OF THE DRAWINGS

FIG. 1 is a first configuration example of a switching regulator.

FIG. 2 is a second configuration example of the switching regulator.

FIG. 3 is a waveform diagram illustrating an operation of the switching regulator.

FIG. 4 is a detailed configuration example of a control circuit.

FIG. 5 is a detailed configuration example of a pre-driver.

FIG. 6 is a truth table illustrating an operation of the pre-driver.

FIG. 7 is a detailed configuration example of a pulse modulation control circuit.

FIG. 8 is a detailed configuration example of an off-timer in the case in which the length of an off-time is variable.

FIG. 9 is a waveform example illustrating a continuous operation of the switching regulator.

FIG. 10 is a waveform example illustrating a discontinuous operation of the switching regulator.

FIG. 11 is a waveform example schematically illustrating a transient operation in the case in which a first comparator and a second voltage divider circuit are not provided.

FIG. 12 is a waveform example schematically illustrating a transient operation in the case in which the first comparator and the second voltage divider circuit are provided.

FIG. 13 is an operation simulation waveform example of the switching regulator.

### DESCRIPTION OF EMBODIMENTS

Hereinafter, a preferred embodiment of the present disclosure is explained in detail. Note that the present embodiment explained below does not unduly limit the content described in the claims, and all of the components explained in the present embodiment are not always essential elements.

### 1. Configuration Examples

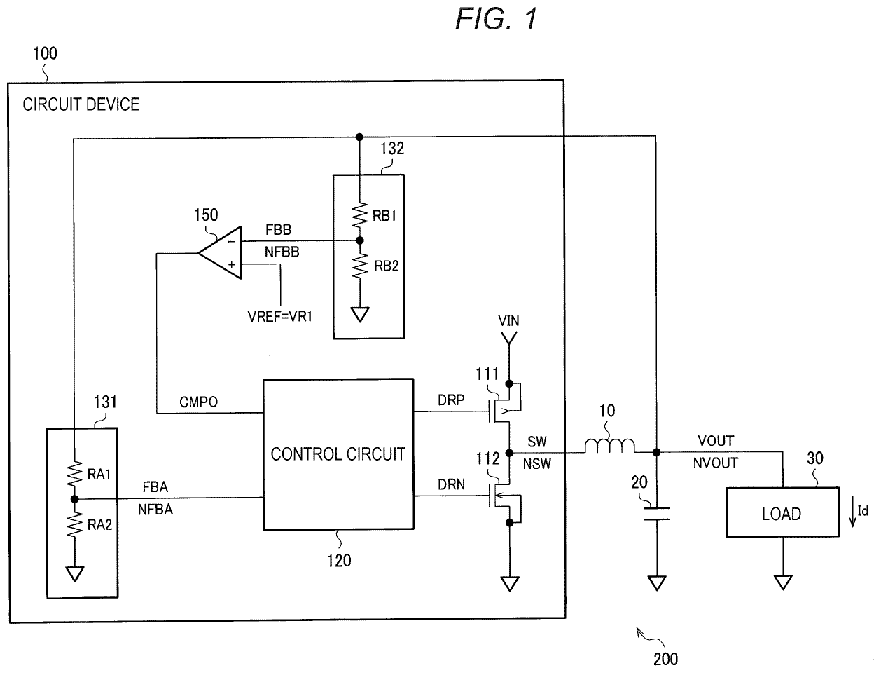

FIG. 1 is a first configuration example of a switching regulator 200. The switching regulator 200 includes a circuit 100, an inductor 10, and a capacitor 20. The switching regulator 200 is also called DCDC converter. The inductor 10 is also called coil.

The switching regulator 200 regulates a power supply voltage VIN to an output voltage VOUT and supplies the output voltage VOUT to a load 30. A not-illustrated power supply circuit is provided on the outside or the inside of the circuit device 100 and the power supply voltage VIN is supplied from the power supply circuit to the circuit device 100. The load 30 is, for example, a microcomputer that controls electronic equipment including the switching regulator 200 but is not limited thereto and may be various circuits.

The circuit device 100 includes a switching element 111, an N-type MOS transistor 112, a control circuit 120, a first voltage divider circuit 131, a second voltage divider circuit 132, and a first comparator 150. The circuit device 100 is, for example, an integrated circuit device in which a plurality of circuit elements are integrated on a semiconductor substrate. FIG. 1 illustrates an example in which the switching element 111 and the N-type MOS transistor 112 are incorporated in the circuit device 100. However, those may be provided on the outside of the circuit device 100. FIG. 1 illustrates an example in which the inductor 10 and the capacitor 20 are provided on the outside of the circuit device 100. However, one or both of them may be built in the circuit device 100.

The switching element 111 is a P-type MOS transistor. A source of the switching element 111 is coupled to a node of the power supply voltage VIN and a drain thereof is coupled to a node NSW. A drive signal DRP from the control circuit 120 is input to a gate of the switching element 111. When the switching element 111 is on, the inductor 10 is driven by the power supply voltage VIN. The switching element 111 only has to be an element that can be switched by control from the control circuit 120 and may be, for example, an N-type MOS transistor or a bipolar transistor.

A source of the N-type MOS transistor 112 is coupled to a ground node and a drain thereof is coupled to the node NSW. A drive signal DRN from the control circuit 120 is input to a gate of the N-type MOS transistor 112. Here, an example in which the switching regulator 200 is a synchronous type is explained above. However, when the switching regulator 200 is an asynchronous type, a diode may be provided instead of the N-type MOS transistor. An anode of the diode may be coupled to the ground node and a cathode thereof may be coupled to the node NSW.

One end of the inductor 10 is coupled to the node NSW and the other end thereof is coupled to an output node NVOUT from which the output voltage VOUT is output. One end of the capacitor 20 is coupled to the output node NVOUT and the other end thereof is coupled to the ground node.

The first voltage divider circuit 131 divides the output voltage VOUT and outputs a first feedback voltage FBA, which is a result of the division, to a node NFBA. The first voltage divider circuit 131 includes a resistor RA1 and a resistor RA2. One end of the resistor RA1 is coupled to the output node NVOUT, and the other end thereof is coupled to the node NFBA. One end of the resistor RA2 is coupled to the node NFBA and the other end thereof is coupled to the ground node. A voltage division ratio is RA2/(RA1+RA2) and FBA=VOUT×(RA2/(RA1+RA2)).

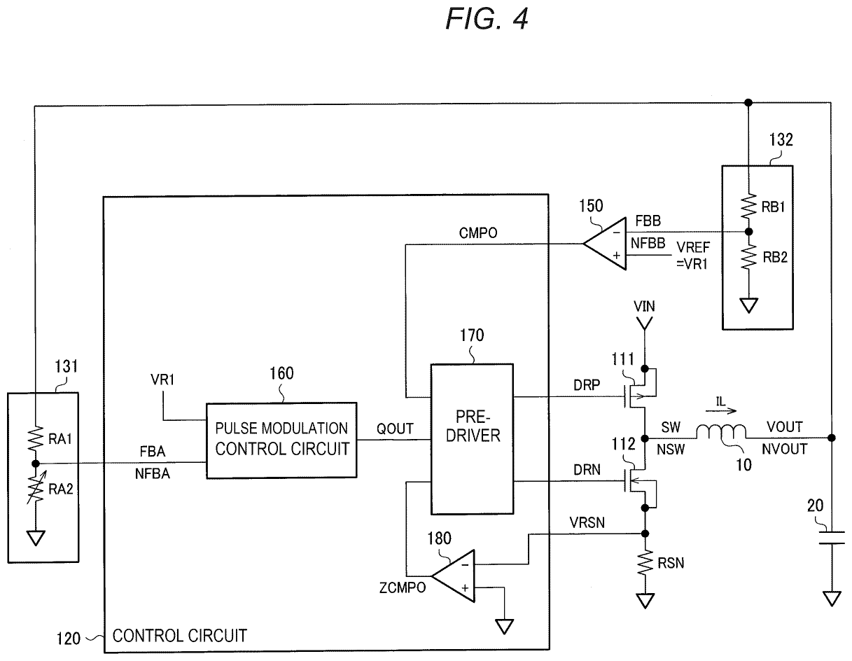

The control circuit 120 performs pulse modulation control on the drive signal DRP and the drive signal DRN to set the first feedback voltage FBA to a constant voltage, that is, such that the output voltage VOUT reaches a given constant voltage. Hereinafter, the given constant voltage is sometimes referred to as target voltage. The pulse modulation control is, for example, pulse width modulation (PWM) or pulse frequency modulation (PFM). However, various modulation methods similar thereto may be used. For example, in FIG. 4 and subsequent figures, the off-timer controls the off-time according to a current value of a load current Id flowing to the load 30 to switch the PFM and the PWM. However, a fixed modulation method may be used regardless of the load current Id.

The second voltage divider circuit 132 divides the output voltage VOUT and outputs a second feedback voltage FBB, which is a result of the division, to a node NFBB. The second voltage divider circuit 132 includes a resistor RB1 and a resistor RB2. One end of the resistor RB1 is coupled to the output node NVOUT, and the other end thereof is coupled to the node NFBB. One end of the resistor RB2 is coupled to the node NFBB and the other end thereof is coupled to the ground node. A voltage division ratio is RB2/(RB1+RB2) and FBB=VOUT×(RB2/(RB1+RB2)). The voltage division ratio RB2/(RB1+RB2) is set such that FBB>VREF when the output voltage VOUT does not transiently change, that is, when the output voltage VOUT is kept at the given constant voltage.

The first comparator 150 compares the second feedback voltage FBB and the reference voltage VREF and outputs a result of the comparison as a detection signal CMPO. The reference voltage VREF may be supplied from, for example, a not-illustrated voltage generation circuit provided in the circuit device 100 or may be supplied from the outside of the circuit device 100. The reference voltage VREF is, for example, a first reference voltage VR1 input to a pulse modulation control circuit 160 explained below with reference to FIG. 4. However, the reference voltage VREF may be different from the first reference voltage VR1.

FIG. 1 illustrates an example in which the second feedback voltage FBB is input to a negative electrode input terminal of the first comparator 150 and the first reference voltage VR1 is input to a positive electrode input terminal thereof. The first comparator 150 has hysteresis and a voltage width of the hysteresis is represented as ΔVHis. When the output voltage VOUT transiently fluctuates, the second feedback voltage FBB also transiently fluctuates. At this time, the first comparator 150 operates as follows. That is, when the detection signal CMPO is at a low level, the detection signal CMPO changes to a high level when the second feedback voltage FBB drops and reaches the first reference voltage VR1. When the detection signal CMPO is at the high level, the detection signal CMPO changes to the low level when the second feedback voltage FBB rises and reaches VR1+ΔVHis.

The control circuit performs the pulse modulation control based on the first feedback voltage FBA when the detection signal CMPO is at the low level and fixes the switching element 111 to ON and fixes the N-type MOS transistor 112 to OFF when the detection signal CMPO is at the high level. That is, after the second feedback voltage FBB drops and reaches the first reference voltage VR1, until the second feedback voltage FBB rises and reaches VR1+ΔVHis, the pulse modulation control is ignored, the switching element 111 is fixed to ON, and the inductor 10 is driven by the power supply voltage VIN.

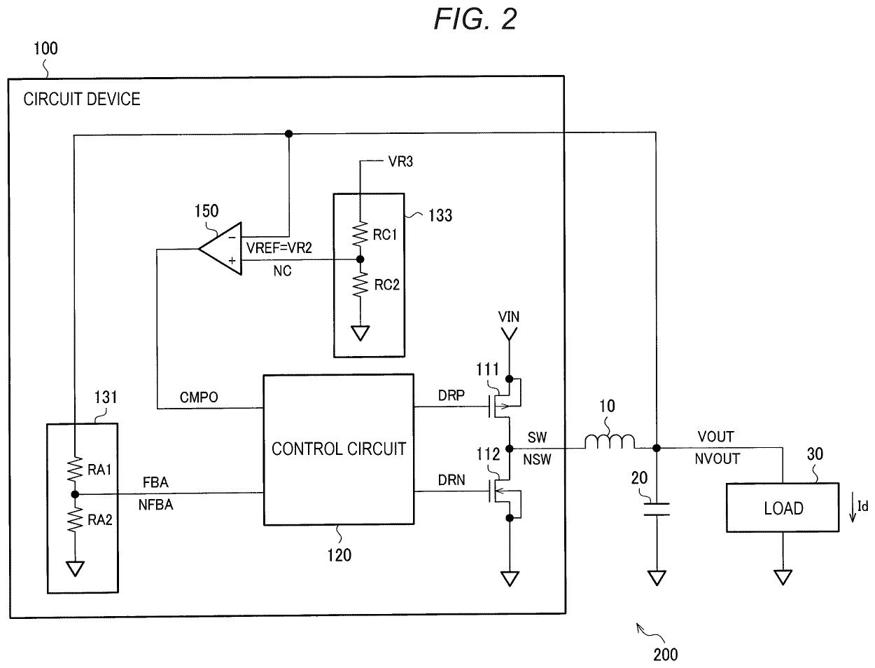

FIG. 2 is a second configuration example of the switching regulator 200. Differences from the first configuration example are explained below.

The circuit device 100 includes a third voltage divider circuit 133. The third voltage divider circuit 133 divides a third reference voltage VR3 and outputs a second reference voltage VR2 as a result of the division to a node NC. The third voltage divider circuit 133 includes resistor RC1 and a resistor RC2. One end of the resistor RC1 is coupled to a node of the third reference voltage VR3 and the other end thereof is coupled to the node NC. One end of the resistor RC2 is coupled to the node NC and the other end thereof is coupled to the ground node. A voltage division ratio is RC2/(RC1+RC2) and VR2=VR3×(RC2/(RC1+RC2)). The voltage division ratio RC2/(RC1+RC2) is set such that VOUT>VR2 when the output voltage VOUT does not transiently change, that is, when the output voltage VOUT is kept at the given constant voltage.

The output voltage VOUT is input to the negative electrode input terminal of the first comparator 150 as a second feedback voltage and the second reference voltage VR2 is input to the positive electrode input terminal thereof as the reference voltage VREF. When the output voltage VOUT transiently fluctuates, the first comparator 150 operates as follows. That is, when the detection signal CMPO is at the low level, the detection signal CMPO changes to the high level when the output voltage VOUT drops and reaches the second reference voltage VR2. When the detection signal CMPO is at a high level, the detection signal CMPO changes to the low level when the output voltage VOUT rises and reaches VR2+ΔVHis.

The configuration illustrated in FIG. 2 is an example. VOUT>VR2 only has to hold when the output voltage VOUT is kept at the given constant voltage. For example, the first feedback voltage FBA and the second feedback voltage FBB may have the same potential. As an example of such a configuration, the first voltage divider circuit 131 may be omitted and the output voltage VOUT may be used as the first feedback voltage FBA. For example, the control circuit 120 performs the pulse modulation control such that VOUT=VR1. At this time, the voltage division ratio of the third voltage divider circuit 133 is set such that VR1>VR2. Accordingly, VOUT=VR1>VR2 holds. A voltage divider circuit that divides VR3 and outputs VR1 may be further provided.

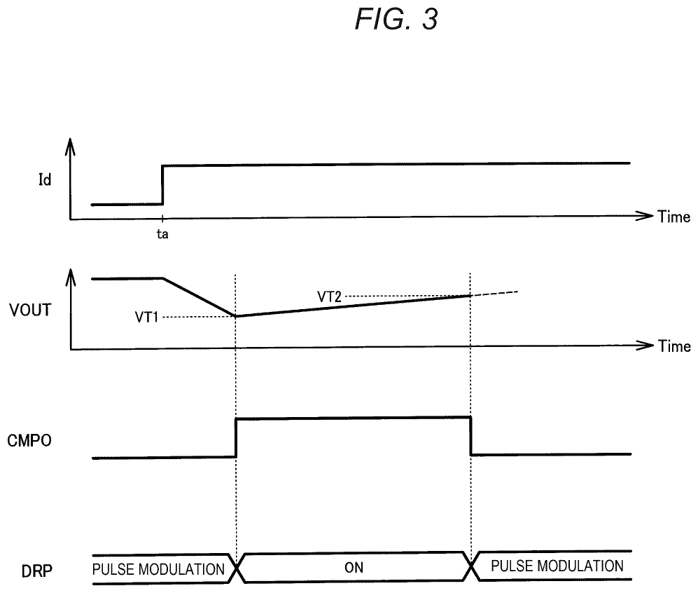

FIG. 3 is a waveform diagram illustrating an operation of the switching regulator 200. Hereinafter, the feedback control via the first voltage divider circuit 131 and the control circuit 120 is referred to as first feedback control and the feedback control via the second voltage divider circuit 132, the first comparator 150, and the control circuit 120 is referred to as second feedback control.

As illustrated in FIG. 3, it is assumed that the load current Id is constant before time ta and the output voltage VOUT is stable at the target voltage. The control circuit 120 performs the pulse modulation control on the switching element 111 with the drive signal DRP based on the first feedback control. At this time, it is assumed that the load current Id suddenly increases at the time ta. The first feedback control responds to fluctuation in the load current Id to keep the output voltage VOUT constant. However, the response of the first feedback control is delayed, whereby the output voltage VOUT transiently drops. If there is no second feedback control, the drop in the output voltage VOUT continues until the first feedback control responds.

In this regard, in the present embodiment, when the output voltage VOUT reaches the first threshold voltage VT1, the detection signal CMPO changes to the high level according to the second feedback control and the control circuit 120 turns on the switching element 111 with the drive signal DRP based on the detection signal CMPO. Then, the detection signal CMPO is maintained at the high level by the second feedback control until the output voltage VOUT rises to the second threshold voltage VT2. The control circuit 120 maintains the switching element 111 on. The first threshold voltage VT1 satisfies VT1×(RA2/(RA1+RA2))=VR1 in the configuration example illustrated in FIG. 1 and VT1=VR2 in the configuration example illustrated in FIG. 2. The second threshold voltage VT2 satisfies VT2×(RA2/(RA1+RA2))=VR1+ΔVHis in the configuration example illustrated in FIG. 1 and VT2=VR2+ΔVHis in the configuration example illustrated in FIG. 2. ΔVHis is a voltage width of hysteresis of the first comparator 150.

As explained above, according to the present embodiment, since a lower limit of the output voltage VOUT is near the first threshold voltage VT1 according to the second feedback control, the drop in the output voltage VOUT is suppressed even when the response of the first feedback control is delayed. After the output voltage VOUT reaches the second threshold voltage VT2 according to the second feedback control, the first feedback control is performed. At this time, it is also conceivable that the output voltage VOUT drops again. However, when the output voltage VOUT drops to the first threshold voltage VT1, the second feedback control is performed again. Therefore, the output voltage VOUT is kept at the first threshold voltage VT1 or higher. When an operating point of the first feedback control sufficiently follows the fluctuation in the load current Id, the output voltage VOUT gradually approaches the target voltage and becomes stable.

Note that the delay of the response of the first feedback control includes, for example, when the control circuit 120 performs timer control for an off-time of the switching element 111, a time until the off-time ends. Alternatively, when the control circuit 120 includes a circuit that requires a time to change the operating point, such as an error amplifier, the delay includes the time required to change the operating point. However, these are examples of the delay. Various delays can occur according to configurations of the pulse modulation control. The second feedback control is configured to be capable of responding faster compared with the pulse modulation control to thereby suppress a transient drop in the output voltage VOUT.

Although an example in which the detection signal CMPO in the second feedback control is high active is explained above, the circuit device 100 may be configured such that the detection signal CMPO is low active.

Although an example in which the switching regulator 200 is a step-down DCDC converter is explained above, the switching regulator 200 may be a step-up DCDC converter. In this case, one end of the inductor 10 may be coupled to the node of the power supply voltage VIN. The switching element 111 may be an N-type MOS transistor, a source thereof may be coupled to the ground node, and a drain thereof may be coupled to the other end of the inductor 10. Taking an asynchronous type as an example, an anode of a diode may be coupled to the other end of the inductor 10 and a cathode thereof may be coupled to a node of the output voltage VOUT. One end of the capacitor 20 may be coupled to the node of the output voltage VOUT and the other end thereof may be coupled to the ground node.

In the present embodiment, the circuit device 100 is used in the switching regulator 200. The switching regulator 200 outputs the output voltage VOUT obtained by regulating the power supply voltage VIN with the inductor 10 and the switching element 111 that drives the inductor 10. The circuit device 100 includes the control circuit 120 and the first comparator 150. The control circuit 120 receives input of the first feedback voltage FBA corresponding to the output voltage VOUT, performs the pulse modulation control for controlling the output voltage VOUT to the given constant voltage based on the first feedback voltage FBA, and performs switching control on the switching element 111 based on a result of the pulse modulation control. The first comparator 150 receives input of the second feedback voltage FBB corresponding to the output voltage VOUT, compares the second feedback voltage FBB and the reference voltage VREF, and outputs the detection signal CMPO that becomes active when the second feedback voltage FBB becomes equal to or lower than the reference voltage VREF. The control circuit 120 turns on the switching element 111 when the detection signal CMPO becomes active.

According to the present embodiment, in addition to the first feedback control for controlling the switching element 111 based on the first feedback voltage FBA, the second feedback control for controlling the switching element 111 based on the second feedback voltage FBB is added. In the case of only the first feedback control, there is a problem in that the output voltage VOUT transiently drops because of the delay of the first feedback control with respect to the fluctuation in the load current Id. In this regard, according to the present embodiment, when the output voltage VOUT drops, the switching element 111 is turned on by the high-speed second feedback control, which is the comparison by the first comparator 150. Accordingly, the transient drop in the output voltage VOUT can be reduced. Specifically, the lower limit of the output voltage VOUT can be set near the first threshold voltage VT1 corresponding to the reference voltage VREF.

In the present embodiment, the first comparator 150 may output the active detection signal CMPO from when the output voltage VOUT becomes equal to or lower than the first threshold voltage VT1 corresponding to the reference voltage VREF until when the output voltage VOUT exceeds the second threshold voltage VT2 by hysteresis of the first comparator 150. The control circuit 120 may maintain the switching element 111 on while the detection signal CMPO is active.

According to the present embodiment, when the output voltage VOUT drops to the first threshold voltage VT1, the switching element 111 is turned on, whereby the inductor 10 is driven and the output voltage VOUT rises. Since the switching element 111 is maintained on, the output voltage VOUT rises until reaching the second threshold voltage VT2. As explained above, since the second feedback control is provided, the output voltage VOUT is controlled not to drop lower than near the first threshold voltage VT1.

### 2. Detailed Configuration Examples

Hereinafter, an example of a detailed configuration of the control circuit 120 and an operation example of the first feedback control and the second feedback control in the example are explained. FIG. 4 illustrates a detailed configuration example of the control circuit 120. The control circuit 120 includes the pulse modulation control circuit 160, a pre-driver 170, and a backflow detection circuit 180.

A path of the first feedback control is explained. The pulse modulation control circuit 160 performs the pulse modulation control to cause the first feedback voltage FBA and the first reference voltage VR1 to coincide with each other and outputs a result of the pulse modulation control as the pulse signal QOUT. The first reference voltage VR1 may be supplied from, for example, a not-illustrated voltage generation circuit provided in the circuit device 100 or may be supplied from the outside of the circuit device 100. The backflow detection circuit 180 detects a backflow of the inductor current IL flowing to the inductor 10. Specifically, a sense resistor RSN is provided between the source of the N-type MOS transistor 112 and the ground node. The backflow detection circuit 180 is a comparator. The comparator compares a voltage VRSN at one end of the sense resistor RSN and the ground voltage and outputs a result of the comparison as a backflow detection signal ZCMPO. FIG. 4 illustrates an example in which the voltage VRSN is input to a negative electrode input terminal of the comparator, which is the backflow detection circuit, and the ground voltage is input to a positive electrode input terminal thereof. When VRSN<0 V, the backflow detection signal ZCMPO at a high level is output. When the inductor current IL flows backward, since VRSN≥0 V, the backflow detection signal ZCMPO at a low level is output. When the detection signal CMPO is at the high level or the pulse signal QOUT is at the high level, the backflow detection circuit 180 may disable backflow detection and output the backflow detection signal ZCMPO at the high level. The pre-driver 170 performs switching control on the switching element 111 and the N-type MOS transistor 112 based on the pulse signal QOUT and the backflow detection signal ZCMPO.

A path of the second feedback control is explained. FIG. 4 illustrates an example in which the configuration of the second feedback control illustrated in FIG. 1 is applied. However, the configuration of the second feedback control illustrated in FIG. 2 can also be applied. When the detection signal CMPO of the first comparator 150 is at the low level, that is, when a drop in the output voltage VOUT is not detected, the pre-driver 170 drives the switching element 111 and the N-type MOS transistor 112 based on the pulse signal QOUT and the backflow detection signal ZCMPO of the first feedback control. When the detection signal CMPO of the first comparator 150 is at the high level, that is, when a drop in the output voltage VOUT is detected, the pre-driver 170 ignores logic levels of the pulse signal QOUT and the backflow detection signal ZCMPO of the first feedback control, turns on the switching element 111, and turns off the N-type MOS transistor 112.

FIG. 4 illustrates an example in which the reference voltage VREF of the first comparator 150 is the same as the first reference voltage VR1 input to the pulse modulation control circuit 160. At this time, the voltage division ratios of the first voltage divider circuit 131 and the second voltage divider circuit 132 are set such that FBB>FBA. That is, RB2/(RB1+RB2)>RA2/(RA1+RA2). When the output voltage VOUT does not transiently change, that is, when FBA=VR1 holds, FBB>VR1. Accordingly, in a steady state, when the first comparator 150 does not react, the switching is controlled by the first feedback control, and the output voltage VOUT drops, the second feedback control operates.

The voltage division ratio of the first voltage divider circuit 131 may be variable. For example, the resistor RA2 may be a variable resistor. Since the output voltage VOUT is controlled such that VOUT×(RA2/(RA1+RA2))=VREF, a voltage value of the output voltage VOUT is variably set by setting the voltage division ratio variable. For example, the circuit device 100 may include a register or a nonvolatile memory that stores setting information of the voltage division ratio and the voltage division ratio of the first voltage divider circuit 131 may be set based on the setting information.

FIG. 5 is a detailed configuration example of the pre-driver 170. The pre-driver 170 includes a NOR circuit 171, an AND circuit 172, and a dead time generation circuit 179.

The NOR circuit 171 receives input of the detection signal CMPO and the pulse signal QOUT and outputs a NOR signal ORQ of the detection signal CMPO and the pulse signal QOUT.

The dead time generation circuit 179 includes an inverted input AND circuit 173, an inverter circuit 174, an AND circuit 175, and a non-inverting buffer 176. The circuits are coupled as illustrated. The dead time generation circuit 179 outputs the drive signal DRP and the signal DRNB having the same logic level as the signal ORQ. The dead time generation circuit 179 generates a dead time when the logic level of the signal ORQ transitions. The dead time is a period in which both of the switching element 111 and the N-type MOS transistor 112 are temporarily off. Specifically, when the signal ORQ transitions between the high level and the low level, the dead time generation circuit 179 temporarily outputs the high level drive signal DRP and the low level signal DRNB.

The AND circuit 172 receives input of the signal DRNB and the backflow detection signal ZCMPO and outputs a logical product of the signal DRNB and the backflow detection signal ZCMPO as the drive signal DRN.

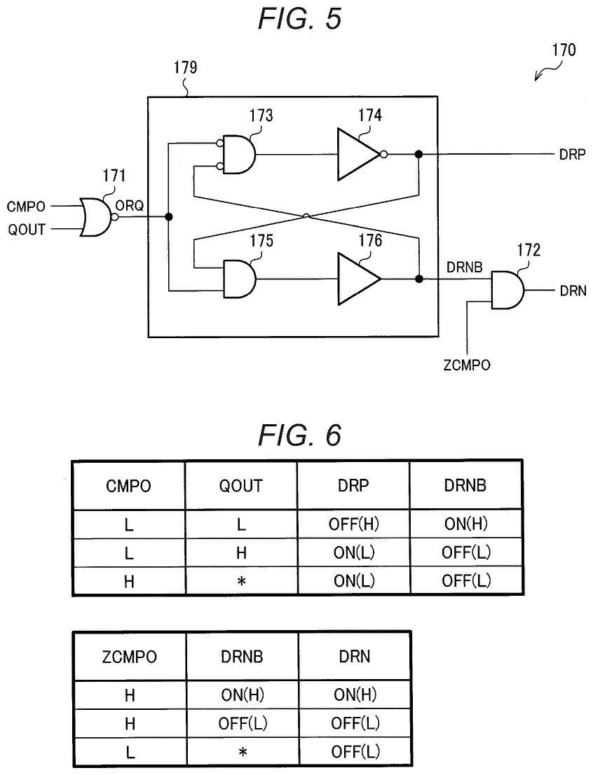

FIG. 6 is a truth table illustrating an operation of the pre-driver 170. Here, a dead time is not considered. In FIG. 6, “L” indicates the low level, “H” indicates the high level, and “*” indicates Don't Care. Concerning the drive signal DRP relating to on/off of the switching element 111 and the signal DRNB and the drive signal DRN relating to on/off of the N-type MOS transistor 112, ON or OFF and a logic level are described together like “ON (H)” or the like.

As illustrated in an upper table, when the detection signal CMPO is at the low level, that is, when a drop in the output voltage VOUT is not detected in the second feedback control, the drive signal DRP and the signal DRNB are signals exclusively indicating ON or OFF according to the pulse signal QOUT. When the detection signal CMPO is at the high level, that is, when a drop in the output voltage VOUT is detected in the second feedback control, the drive signal DRP is a signal indicating ON and the signal DRNB is a signal indicating OFF regardless of a logic level of the pulse signal QOUT.

As illustrated in a lower table, when the backflow detection signal ZCMPO is at the high level, that is, when a backflow is not detected, the drive signal DRN having the same logic level as the signal DRNB is output. When the backflow detection signal ZCMPO is at the low level, that is, when a backflow is detected, the drive signal DRN is a signal indicating OFF regardless of a logic level of the signal DRNB.

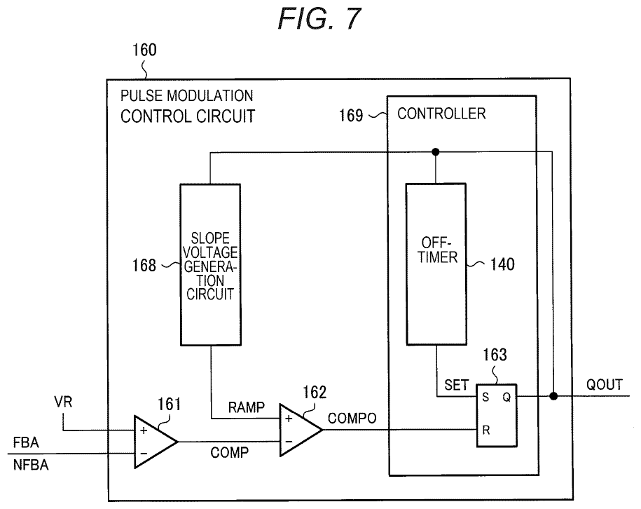

FIG. 7 is a detailed configuration example of the pulse modulation control circuit 160. The pulse modulation control circuit 160 includes an error amplifier 161, a second comparator 162, a slope voltage generation circuit 168, and a controller 169. The controller 169 includes an off-timer 140 and an RS latch circuit 163.

The error amplifier 161 amplifies the error between the first feedback voltage FBA and the first reference voltage VR1 and outputs a result of the amplification as an error voltage COMP. FIG. 7 illustrates an example in which the first feedback voltage FBA is input to a negative electrode input terminal of the error amplifier 161 and the first reference voltage VR1 is input to a positive electrode input terminal thereof. In this case, the error amplifier 161 drops the error voltage COMP when FBA>VR1 and raises the error voltage COMP when FBA<VR1. The error amplifier 161 is an integration circuit that integrates the difference between the first feedback voltage FBA and the first reference voltage VR1 and includes, for example, an operational amplifier and an integration capacitor. The first reference voltage VR1 is input to a positive electrode input terminal of the operational amplifier, the first feedback voltage FBA is input to a negative electrode input terminal of the operational amplifier, and a voltage difference between an output terminal and the negative electrode input terminal of the operational amplifier is fed back by the integration capacitor.

The first feedback voltage FBA output by the first voltage divider circuit 131 is controlled to be close to the first reference voltage VR1 by virtual short of the operational amplifier and fluctuation in the output voltage VOUT is not directly reflected on the first feedback voltage FBA. In this regard, by providing the second voltage divider circuit 132 anew, the fluctuation in the output voltage VOUT is directly reflected in the second feedback voltage FBB. Accordingly, in the second feedback control, a drop in the output voltage VOUT is appropriately detected.

The slope voltage generation circuit 168 generates a slope voltage RAMP, which rises with elapse of time when the pulse signal QOUT is at the high level, and resets the slope voltage RAMP when the pulse signal QOUT is at the low level. The slope voltage is also called a triangular wave. The reset of the slope voltage RAMP means the slope voltage RAMP being initialized to an initial voltage of the slope voltage RAMP, that is, a voltage at which a slope is started.

The second comparator 162 compares the error voltage COMP with the slope voltage RAMP and outputs a result of the comparison as an output signal COMPO. FIG. 7 illustrates an example in which the error voltage COMP is input to a negative electrode input terminal of the second comparator 162 and the slope voltage RAMP is input to a positive electrode input terminal thereof.

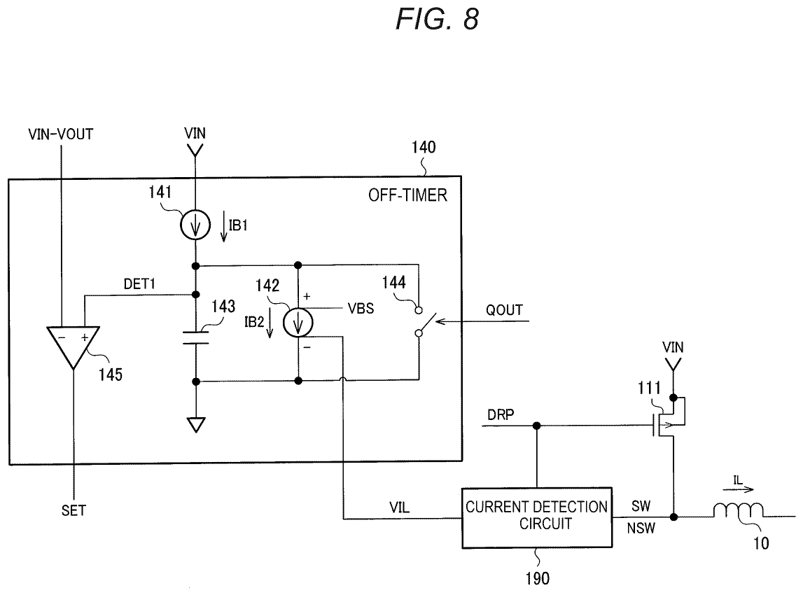

The off-timer 140 starts a timer when the pulse signal QOUT changes from the high level to the low level, that is, when the switching element 111 changes from ON to OFF. When the off-timer 140 measures elapse of the off-time, the off-timer 140 changes the set signal SET of the RS latch circuit 163 from the low level to the high level. Accordingly, the pulse signal QOUT changes from the low level to the high level and, in response to this, the off-timer 140 resets the timer and changes the set signal SET from the high level to the low level. The off-time measured by the off-timer 140 is a period for setting the length of a time in which the switching element 111 is off. The length of the off-time may be fixed or may be variably controlled according to the inductor current IL as explained below with reference to FIG. 8.

The RS latch circuit 163 receives input of the set signal SET from the off-timer 140, receives input of the output signal COMPO from the second comparator 162 as a reset signal, and outputs the pulse signal QOUT based on the set signal and the reset signal.

FIG. 8 is a detailed configuration example of the off-timer 140 in the case in which the length of the off-time is variable. When this configuration example is applied, the circuit device 100 further includes a current detection circuit 190.

The current detection circuit 190 detects the inductor current IL and outputs a result of the detection as the voltage VIL. The voltage VIL is a voltage that rises when the inductor current IL increases. As an example, the current detection circuit 190 includes a current mirror transistor corresponding to the switching element 111. The current detection circuit 190 inputs the drive signal DRP to a gate of the current mirror transistor and sets a drain of the current mirror transistor to a voltage SW of the node NSW to mirror a drain current of the switching element 111. The current detection circuit 190 converts a mirror current into a voltage with a resistor or the like, peak-holds the converted voltage with a switch, a capacitor, and the like, and outputs the voltage VIL based on the peak-held voltage.

The off-timer 140 includes a current source 141, a variable current source 142, a capacitor 143, a switch 144, and a comparator 145.

When the pulse signal QOUT is at the high level, that is, when the switching element 111 is on, the switch 144 is on. At this time, since both ends of the capacitor 143 are short-circuited to the ground, a voltage DET1 drops to 0 V. Since VIN−VOUT>0 V in the step-down DCDC converter, the comparator 145 outputs the set signal SET of the low level.

When the pulse signal QOUT is at the low level, that is, when the switching element 111 is off, the switch 144 is off. A capacitance value of the capacitor 143 is described as Coff. An output current IB1 of the current source 141 is described as VIN/Roff. An output current IB2 of the variable current source 142 is 0 A when VIL≥VBS and is g2×(VBS−VIL) when VIL<VBS. VBS is a bias voltage supplied from a not-illustrated voltage generation circuit. g2 is a coefficient of voltage-current conversion in the variable current source 142. At this time, the voltage DET1 is charged by an electric current (IB1−IB2) and rises. When DET1>VIN−VOUT, the comparator 145 changes the set signal SET from the low level to the high level. Accordingly, the pulse signal QOUT changes from the low level to the high level.

A time when the pulse signal QOUT is at the low level is the off-time. When the off-time is represented as Toff, Toff=Coff×(VIN−VOUT)/(IB1−IB2). When the load current Id is large, the inductor current IL increases and the voltage VIL rises. When VIL≥VBS, IB2=0 A and, at this time, Toff=(1−VOUT/VIN)×Roff×Coff. The length of the off-time Toff is constant regardless of the inductor current IL. In the sense that only the on-time is controlled, this is equivalent to PWM control. When the load current Id is small, the inductor current IL decreases and the voltage VIL drops. When VIL<VBS, IB2=g2×(VBS−VIL). Since the voltage VIL drops and the electric current IB2 increases as the inductor current IL decreases, the length of the off-time Toff increases. In the sense that the off-time is controlled according to the inductor current IL, this is equivalent to PFM control.

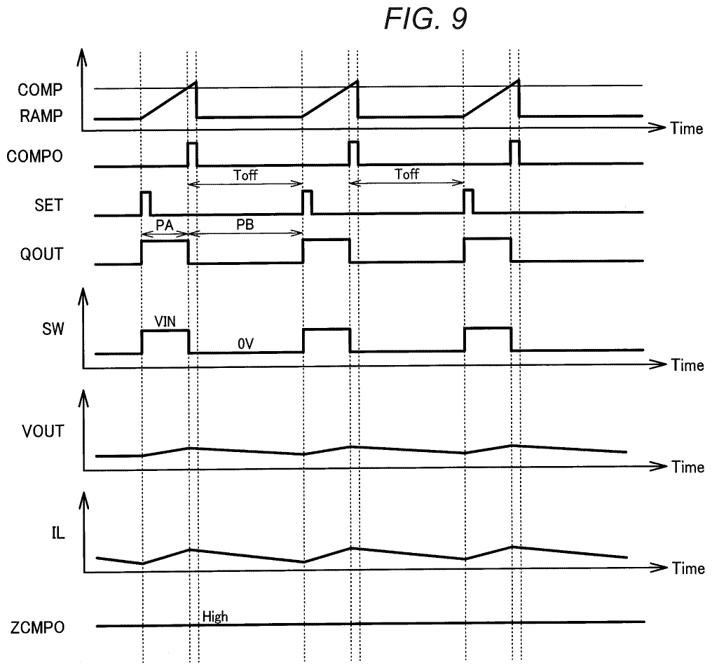

FIG. 9 is a waveform example illustrating a continuous operation of the switching regulator 200 illustrated in FIGS. 4 to 8. Here, it is assumed that the load current Id does not fluctuate and the pulse modulation control in the first feedback control is performed. The continuous operation is an operation in the case in which the load current Id is relatively large and a backflow of the inductor current IL does not occur. Since a backflow does not occur, the backflow detection signal ZCMPO is at the high level.

A period PA is a period in which the switching element 111 is on and the N-type MOS transistor 112 is off. In the period PA, the voltage SW of the node NSW reaches the power supply voltage VIN, the inductor current IL increases, and the output voltage VOUT rises. A period PB is a period in which the switching element 111 is off and the N-type MOS transistor 112 is on. In the period PB, the voltage SW of the node NSW drops to 0 V, the inductor current IL decreases, and the output voltage VOUT drops. In the continuous operation, the period PA and the period PB constitute one cycle of switching. Fluctuation in the output voltage VOUT and the inductor current IL due to the switching is so-called ripple.

In the continuous operation, the off-time Toff is equivalent to the period PB. When the off-time Toff ends, the off-timer 140 changes the set signal SET from the low level to the high level. In response to this, the RS latch circuit 163 changes the pulse signal QOUT from the low level to the high level. In response to this, the off-timer 140 changes the set signal SET from the high level to the low level and the slope voltage generation circuit 168 starts generating the slope voltage RAMP. When the slope voltage RAMP reaches the error voltage COMP, the second comparator 162 changes the output signal COMPO from the low level to the high level. Receiving the output signal COMPO as a reset signal, the RS latch circuit 163 changes the pulse signal QOUT from the high level to the low level. In response to this, the slope voltage generation circuit 168 resets the slope voltage RAMP and the off-timer 140 starts measuring the off-time Toff. When the slope voltage RAMP is reset and RAMP<COMP, the second comparator 162 changes the output signal COMPO from the high level to the low level. The off-timer 140 changes the set signal SET from the low level to the high level when the off-time Toff elapses. Thereafter, the same operation is repeated.

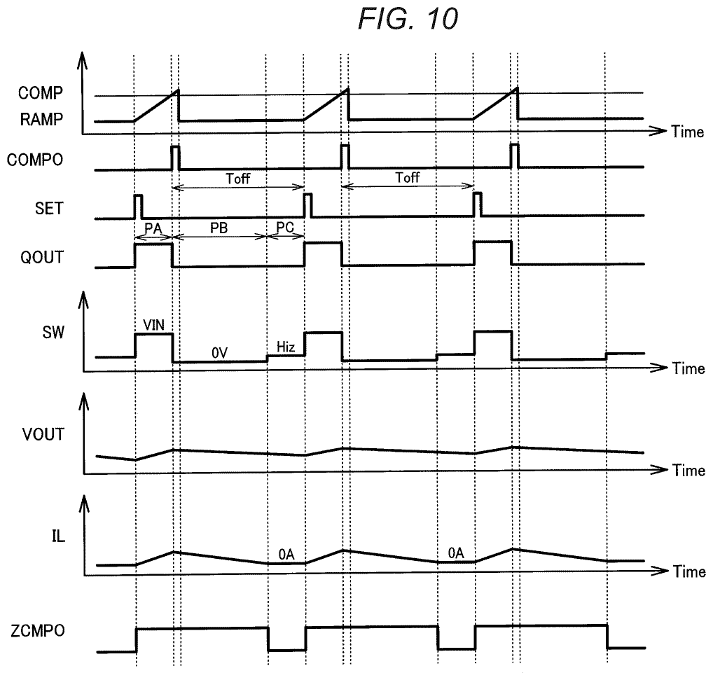

FIG. 10 is a waveform example illustrating a discontinuous operation of the switching regulator 200 illustrated in FIGS. 4 to 8. Here, it is assumed that the load current Id does not fluctuate and the pulse modulation control in the first feedback control is performed. The discontinuous operation is an operation in the case in which the load current Id is relatively small and a backflow of the inductor current IL occurs. Hereinafter, differences from FIG. 9 are mainly explained.

A period PC is a period in which the switching element 111 is off and the N-type MOS transistor 112 is off. In the period PC, the node NSW is in a high impedance state and the inductor current IL is 0 A. In the discontinuous operation, a period PA, a period PB, and a period PC constitute one cycle of switching.

In the discontinuous operation, the off-time Toff is equivalent to the period PB and the period PC. In the period PB, when the inductor current IL decreases and reaches 0 A, the backflow detection signal ZCMPO changes the backflow detection signal ZCMPO from the high level to the low level. In response to this, the pre-driver 170 changes the N-type MOS transistor 112 from on to off. Accordingly, the period PC starts and, since the N-type MOS transistor 112 is off, a backflow of the inductor current IL is prevented. When the off-time Toff ends, the off-timer 140 changes the set signal SET from the low level to the high level. Accordingly, the period PA starts and the same operation as the normal operation illustrated in FIG. 9 is performed until the period PB ends.

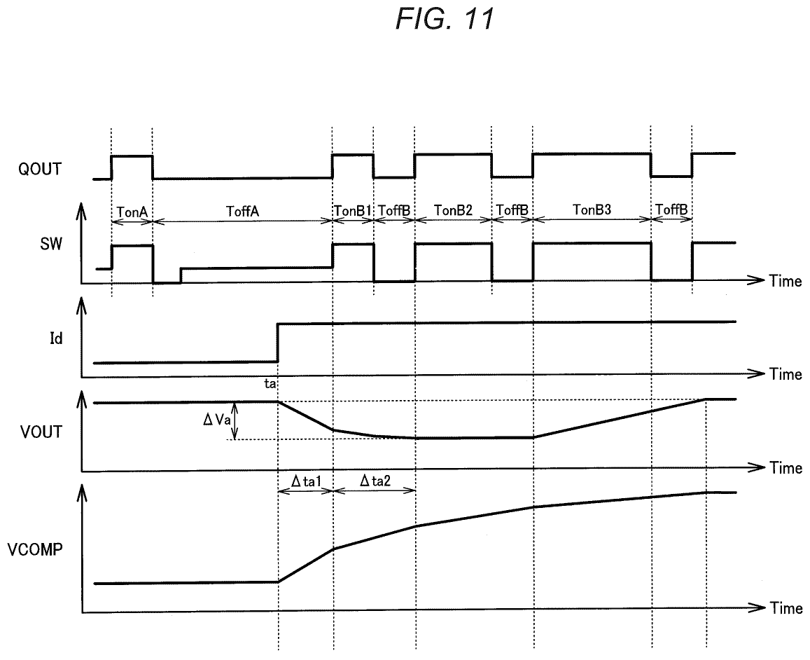

FIG. 11 is a waveform example schematically illustrating a transient operation in the case in which the second feedback control is not provided in the configuration examples illustrated in FIGS. 4 to 8, that is, when the first comparator 150 and the second voltage divider circuit 132 are not provided. Before the time ta, the load current Id is relatively small and the discontinuous operation is performed. It is assumed that the load current Id suddenly increases at the time ta and the continuous operation is performed for the increased load current Id.

TonA represents an on-time in the discontinuous operation and represents off-time ToffA an in the discontinuous operation. In a time Δta1 after the load current Id increases at the time ta until the switching element 111 is turned on next time, the output voltage VOUT drops because the inductor 10 is not driven.

TonB1, TonB2, and TonB3 represent on-times in the continuous operation and ToffB represents an off-time in the continuous operation. Since the load current Id is large, the off-time ToffB is shorter than the off-time ToffA. Since the output voltage VOUT drops, the error voltage COMP rises and the on-times TonB1, TonB2, and TonB3 gradually increase. However, since a certain amount of time is required for the rise in the error voltage COMP, an on-time having sufficient length cannot be obtained for a while after the time ta, and the output voltage VOUT further drops. A time from the continuous operation starts until the drop in the output voltage VOUT stops is represented as Δta2. A drop width of the output voltage VOUT is represented as ΔVa. When a sufficient on-time is obtained according to the rise in the error voltage COMP, the output voltage VOUT rises and returns to the target voltage VOUT. FIG. 11 is made schematic in order to explain the operation. For example, a change in the error voltage COMP after the time ta is actually much gentler than that in FIG. 11. Since the error voltage COMP gently changes after the time ta, the on-time of the pulse signal QOUT in the continuous operation also gently increases.

As explained above, since a response of the first feedback control is delayed with respect to a sudden change in the load current Id, the output voltage VOUT temporarily drops. The drop in the output voltage VOUT is likely to affect an operation of a circuit to which the output voltage VOUT is supplied.

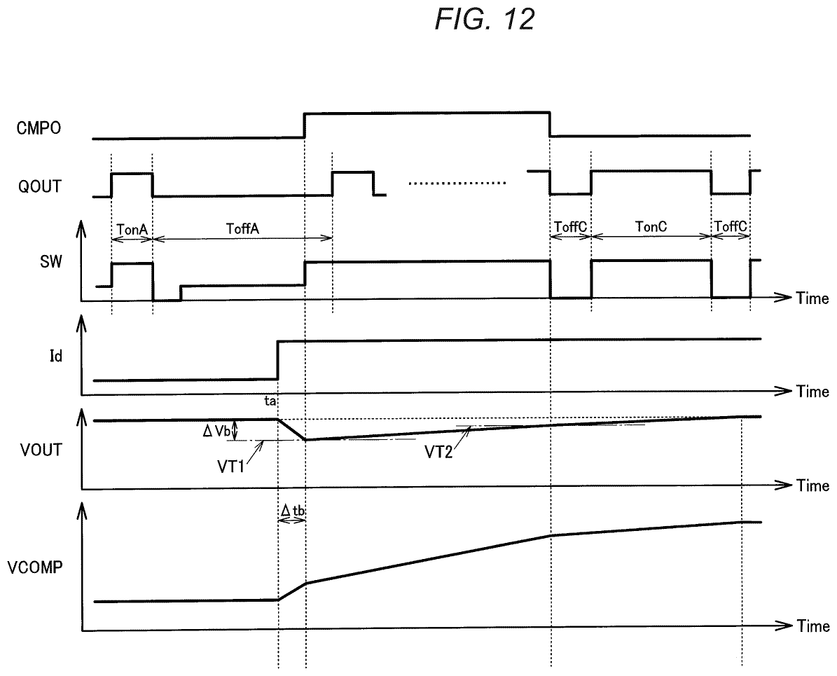

FIG. 12 is a waveform example schematically illustrating a transient operation in the case in which the second feedback control is provided as in the configuration examples illustrated in FIGS. 4 to 8, that is, the first comparator 150 and the second voltage divider circuit 132 are provided. An operation before the time ta is the same as the operation illustrated in FIG. 11.

When the load current Id increases at the time ta, the output voltage VOUT drops. However, when the output voltage VOUT reaches the first threshold voltage VT1, the first comparator 150 changes the detection signal CMPO from the low level to the high level. At this time, the pre-driver 170 ignores the pulse signal QOUT by the first feedback control and turns on the switching element 111. Accordingly, the inductor 10 is driven and the output voltage VOUT rises. A time from the time ta until the output voltage VOUT reaches the first threshold voltage VT1 is represented as Δtb. The difference between the target voltage of the output voltage VOUT and the first threshold voltage VT1, that is, a drop width of the output voltage VOUT is represented as ΔVb. Δtb is shorter than Δta1+Δta2 illustrated in FIG. 11 and ΔVb is smaller than ΔVa illustrated in FIG. 11.

The first comparator 150 maintains the detection signal CMPO at the high level until the output voltage VOUT rises and reaches the second threshold voltage VT2. During this period, the switching element 111 is maintained on and the inductor 10 is continuously driven. Since the output voltage VOUT is lower than the target voltage, the error voltage COMP rises.

After the detection signal CMPO changes to the low level, the continuous operation is performed. TonC represents an on-time in the continuous operation and ToffC represents an off-time in the continuous operation. Since the error voltage COMP rises while the detection signal CMPO is at the low level, the on-time TonC is longer compared with the on-time TonB1 illustrated in FIG. 11. If the on-time TonC is sufficiently long, the output voltage VOUT rises and returns to the target voltage.

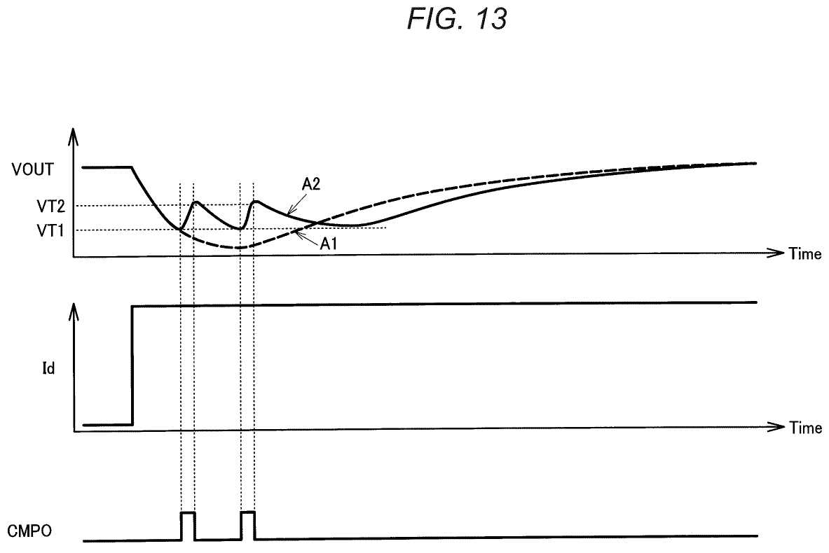

FIG. 13 is an operation simulation waveform example of the switching regulator 200. A line A1 is a waveform of the output voltage VOUT in the case in which the second feedback control is not provided. A line A2 is a waveform of the output voltage VOUT in the case in which the second feedback control is provided. A minimum value of the output voltage VOUT indicated by the line A1 is lower than the first threshold voltage VT1. On the other hand, a minimum value of the output voltage VOUT indicated by the line A2 is the first threshold voltage VT1. A transient drop in the output voltage VOUT is suppressed. In this waveform example, an example is explained in which, after the detection signal CMPO changes to the high level for the first time and the output voltage VOUT rises to the second threshold voltage VT2, the error voltage COMP does not sufficiently rise, the on-time of the switching element 111 is insufficient, and the output voltage VOUT drops again. Even in such a case, when the output voltage VOUT drops to the first threshold voltage VT1, the detection signal CMPO changes to the high level again and the switching element 111 is turned on. When this is repeated and the on-time has a sufficient length, the output voltage VOUT returns to the target voltage. FIG. 13 illustrates an example in which the detection signal CMPO changes to the high level twice.

In the present embodiment, the control circuit 120 includes the pulse modulation control circuit 160 that outputs the pulse signal QOUT according to the pulse modulation control and the pre-driver 170 that performs the switching control on the switching element 111 based on the pulse signal QOUT and the detection signal CMPO. Even when the pulse modulation control circuit 160 is outputting the pulse signal QOUT for turning off the switching element 111, the pre-driver 170 turns on the switching element 111 when the detection signal CMPO is active.

According to the present embodiment, the first feedback control is performed by the pulse modulation control for controlling the output voltage VOUT to the given constant voltage based on the first feedback voltage FBA. Even when the switching element 111 is turned off by the first feedback control, the switching element 111 is turned on when a drop in the output voltage VOUT is detected by the second feedback control, that is, when the detection signal CMPO is active. Accordingly, the fluctuation in the load current Id is not affected by the delay of the first feedback control and a drop in the output voltage VOUT can be suppressed.

In the present embodiment, the second feedback voltage FBB may be a voltage obtained by dividing the output voltage VOUT or may be the output voltage VOUT.

According to the present embodiment, the voltage obtained by dividing the output voltage VOUT or the output voltage VOUT is input to the first comparator 150. Accordingly, the second feedback control is performed based on the second feedback voltage FBB corresponding to the output voltage VOUT.

In the present embodiment, the circuit device 100 may include the first voltage divider circuit 131 that divides the output voltage VOUT and outputs the first feedback voltage FBA to the control circuit 120 and the second voltage divider circuit 132 that divides the output voltage VOUT and outputs the second feedback voltage FBB to the first comparator 150.

Since the second voltage divider circuit 132 is provided separately from the first voltage divider circuit 131, the first feedback voltage FBA used for the first feedback control and the second feedback voltage FBB used for the second feedback control can be separated. Depending on a circuit configuration for the first feedback control, a configuration in which fluctuation in the output voltage VOUT is less easily reflected on the first feedback voltage FBA is also conceivable. In this regard, according to the present embodiment, it is possible to provide, anew, the second feedback voltage FBB on which the fluctuation in the output voltage VOUT is appropriately reflected. A drop in the output voltage VOUT is appropriately detected in the second feedback control using the second feedback voltage FBB.

In the present embodiment, the control circuit 120 may include the error amplifier 161 that amplifies the error between the first feedback voltage FBA and the first reference voltage VR1 and outputs the error voltage COMP.

According to the present embodiment, since the first feedback voltage FBA is controlled to be near the first reference voltage VR1 by feedback of the error amplifier 161, fluctuation in the output voltage VOUT is less easily reflected on the first feedback voltage FBA. In this regard, according to the present embodiment, a drop in the output voltage VOUT is appropriately detected based on the second feedback voltage FBB on which fluctuation in the output voltage VOUT is appropriately reflected.

In the present embodiment, the first reference voltage VR1 may be input to the first comparator 150 as the reference voltage VREF. The voltage division ratios of the first voltage divider circuit 131 and the second voltage divider circuit 132 may be set such that the second feedback voltage FBB is higher than the first feedback voltage FBA.

According to the present embodiment, when the output voltage VOUT does not transiently change, (first feedback voltage FBA)=(first reference voltage VR1) holds. Since the second feedback voltage FBB is set to be higher than the first feedback voltage FBA, (second feedback voltage FBB)>(first reference voltage VR1). Accordingly, the first comparator 150 does not react in the steady state, switching is controlled by the first feedback control, and the second feedback control can operate when the output voltage VOUT drops.

In the present embodiment, the circuit device 100 may include the third voltage divider circuit 133 that divides the third reference voltage VR3 and outputs the second reference voltage VR2. The output voltage VOUT may be input to the first comparator 150 as the second feedback voltage FBB and the second reference voltage VR2 may be input thereto as the reference voltage VREF. The voltage division ratio of the third voltage divider circuit 133 may be set such that the second feedback voltage FBB is higher than the second reference voltage VR2 when the output voltage VOUT is the given constant voltage.

According to the present embodiment, the output voltage VOUT itself can be used as the second feedback voltage FBB input to the first comparator 150. When the output voltage VOUT does not transiently change, the voltage division ratio is set such that (second feedback voltage FBB)> (second reference voltage VR2). Accordingly, the first comparator 150 does not react in the steady state, switching is controlled by the first feedback control, and the second feedback control can operate when the output voltage VOUT drops.

In the present embodiment, the control circuit 120 may include the error amplifier 161 that amplifies the error between the first feedback voltage FBA and the first reference voltage VR1 and outputs the error voltage COMP.

According to the present embodiment, fluctuation in the output voltage VOUT is less easily reflected on the first feedback voltage FBA by feedback of the error amplifier 161. In this regard, according to the present embodiment, since the second feedback control is performed based on the output voltage VOUT itself, a drop in the output voltage VOUT is appropriately detected.

In the present embodiment, the pulse modulation control circuit 160 may include the error amplifier 161 that amplifies the error between the first feedback voltage FBA and the first reference voltage VR1 and outputs the error voltage COMP and the slope voltage generation circuit 168 that generates the slope voltage RAMP. The pulse modulation control circuit 160 may include the second comparator 162 that compares the error voltage COMP and the slope voltage RAMP and the controller 169 that outputs the pulse signal QOUT based on the output signal COMPO of the second comparator 162.

According to the present embodiment, the pulse signal QOUT is output based on the output signal COMPO, which is the comparison result between the error voltage COMP and the slope voltage RAMP, and the switching element 111 is subjected to the switching control based on the pulse signal QOUT. Accordingly, in the first feedback control, the pulse signal QOUT is modulated and controlled such that the output voltage VOUT reaches the given constant voltage.

In the present embodiment, the controller 169 may include the off-timer 140 and the RS latch circuit 163. The off-timer 140 may set the length of the off-time in which the switching element 111 is off. The RS latch circuit 163 may output the pulse signal QOUT for changing the switching element 111 from OFF to ON when the off-time ends and may output the pulse signal QOUT for changing the switching element 111 from ON to OFF when the second comparator 162 determines that the slope voltage RAMP has reached the error voltage COMP.

According to the present embodiment, the off-time is specified by the off-timer 140. The on-time is controlled based on comparison between the error voltage COMP and the slope voltage RAMP such that the output voltage VOUT reaches the given constant voltage. Accordingly, the pulse modulation control of the first feedback control is performed. As explained with reference to FIG. 8, the off-time may change according to the inductor current IL.

Although the present embodiment is explained in detail as explained above, those skilled in the art could easily understand that many modifications can be made without substantially departing from the novel matters and the effects of the present disclosure. Therefore, all such modifications are deemed to be included in the scope of the present disclosure. For example, a term described at least once together with a different term having a broader meaning or the same meaning in the specification or the drawings can be replaced with the different term in any place in the specification or the drawings. All combinations of the present embodiment and the modifications are also included in the scope of the present disclosure. The configurations, operations, and the like of the pulse modulation control circuit, the pre-driver, the control circuit, the first voltage divider circuit, the second voltage divider circuit, the circuit device, the load, the switching regulator, and the like are not limited to those described in the present embodiment, and various modifications can be made.

What is claimed is:

1. A circuit device used in a switching regulator that outputs an output voltage obtained by regulating a power supply voltage with an inductor and a switching element that drives t the inductor, the circuit device comprising:
a control circuit to which a first feedback voltage corresponding to the output voltage is input, the control circuit performing pulse modulation control of controlling the output voltage to a given constant voltage based on the first feedback voltage and performing switching control on the switching element based on a result of the pulse modulation control; and
a first comparator to which a second feedback voltage corresponding to the output voltage is input, the first comparator comparing the second feedback voltage and a reference voltage and outputting a detection signal that becomes active when the second feedback voltage becomes equal to or lower than the reference voltage, wherein
the control circuit turns on the switching element when the detection signal becomes active.

2. The circuit device according to claim 1, wherein
the control circuit includes:
a pulse modulation control circuit configured to output a pulse signal according to the pulse modulation control; and
a pre-driver configured to perform switching control on the switching element based on the pulse signal and the detection signal, and
the pre-driver turns on the switching element when the detection signal is active even when the pulse modulation control circuit outputs the pulse signal for turning off the switching element.

3. The circuit device according to claim 1, wherein
the first comparator outputs the detection signal, which is active, from when the output voltage becomes equal to or lower than a first threshold voltage corresponding to the reference voltage until when the output voltage exceeds a second threshold voltage by hysteresis of the first comparator, and
the control circuit maintains the switching element on while the detection signal is active.

4. The circuit device according to claim 1, wherein the second feedback voltage is a voltage obtained by dividing the output voltage or the output voltage.

5. The circuit device according to claim 1, further comprising:
a first voltage divider circuit configured to divide the output voltage and output the first feedback voltage to the control circuit; and
a second voltage divider circuit configured to divide the output voltage and output the second feedback voltage to the first comparator.

6. The circuit device according to claim 5, wherein the control circuit includes an error amplifier configured to amplify an error between the first feedback voltage and a first reference voltage and output an error voltage.

7. The circuit device according to claim 6, wherein
the first reference voltage is input to the first comparator as the reference voltage, and
voltage division ratios of the first voltage divider circuit and the second voltage divider circuit are set such that the second feedback voltage is higher than the first feedback voltage.

8. The circuit device according to claim 1, further comprising a third voltage divider circuit configured to divide a third reference voltage and output a second reference voltage, wherein
the output voltage is input to the first comparator as the second feedback voltage and the second reference voltage is input to the first comparator as the reference voltage, and
a voltage division ratio of the third voltage divider circuit is set such that the second feedback voltage is higher than the second reference voltage when the output voltage is the given constant voltage.

9. The circuit device according to claim 2, wherein the pulse modulation control circuit includes:
an error amplifier configured to amplify an error between the first feedback voltage and a first reference voltage and output an error voltage;
a slope voltage generation circuit configured to generate a slope voltage;
a second comparator configured to compare the error voltage with the slope voltage; and
a controller configured to output the pulse signal based on an output signal of the second comparator.

10. The circuit device according to claim 9, wherein the controller includes:
an off-timer configured to set length of an off-time in which the switching element is off; and
an RS latch circuit configured to output the pulse signal for changing the switching element from OFF to ON when the off-time ends and output the pulse signal for changing the switching element from ON to OFF when the second comparator determines that the slope voltage reached the error voltage.

11. A switching regulator comprising:
the circuit device according to claim 1;
the switching element; and
the inductor.
